(19) United States
(12) Patent Application Publication
(10) Pub. No.: US 2021/0129956 A1
(43) Pub. Date: May 6, 2021

(54) Lift Vest With Webbing To Reduce Or Eliminate Vertical Sliding

(71) Applicant: James S. Cohen, New York, NY (US)

(72) Inventor: James S. Cohen, New York, NY (US)

(21) Appl. No.: 16/674,883

(22) Filed: Nov. 5, 2019

(51) Int. Cl. B63C 9/11

(52) U.S. Cl. CPC B63C 9/11

(57) ABSTRACT

A lift vest of this disclosure includes a base garment shaped to cover at least a substantial portion of an upper torso of a patient, a waist belt connected to the base garment, and a pair of crotch belts removably connected to the waist belt. The base garment may include a chest a waist belt interconnected by cross-webbing. Pulling on one or both of the belts in any direction causes the webbing to tighten about the wearer's torso. The lift vest may include a pair of knee belts connected to the waist belt. The knee belts can be fixed to the waist belt or removably connected to it. The knee belt may include a removable connection along its length. Other embodiments include a base garment covering the upper torso below the armpits and having a single belt connected to garment that provides a hand hold.

### BACKGROUND

This disclosure is in the field of lift vests that enable a caregiver to assist a patient wearing the vest to move from one position to another. The vests typically include a base garment shaped to cover at least a substantial portion of the torso (chest, abdomen, and back) of the patient and belts connected to the base garment that provide hand holds for the caregiver. U.S. Pat. No. 6,122,778 to Cohen, the contents of which are incorporated by reference herein, provides an example.

The prior art lift vests work best in non-emergency situations, where there is sufficient time to equip the patient with the vest, and when worn by patients that can bear weight. Even when worn by weight-bearing patients, the vest may slide upwards during use, causing the top or chest belt to move upwards towards the patient's arms.

### SUMMARY

Embodiments of a lift vest of this disclosure include a base garment shaped to cover at least a substantial portion of an upper torso of a patient, a waist belt connected to the base garment, and a pair of crotch belts removably connected to the waist belt. Removable connections may include quick-release buckles of a kind known in the art, hook-and-loop fastener of a kind known in the art, or some combination of the two. The connections may be adjustable connections.

In other embodiments, the base garment includes a chest and a waist belt interconnected by cross-webbing. Pulling on one or both of the belts in any direction causes the webbing to tighten about the wearer's torso.

In some embodiments, the lift vest includes a pair of knee belts connected to the waist belt. The knee belts can be fixed to the waist belt or removably connected to it. The knee belt may include a removable connection along its length.

Other embodiments of a lift vest of this disclosure include a base garment covering the upper torso below the armpits and having a single belt connected to garment that provides a hand hold.

### BRIEF DESCRIPTION OF THE DRAWINGS

FIG. 1 is a front elevation view of an embodiment of a lift vest of this disclosure.

FIG. 2 is a rear elevation view of the vest of FIG. 1.

FIG. 3 is a front elevation view of another embodiment of a lift vest of this disclosure.

FIG. 4 is a rear elevation view of the vest of FIG. 3.

FIG. 5 is a front elevation view of yet another embodiment of a lift vest of this disclosure.

FIG. 6 is a side elevation view of the vest of FIG. 5.

FIG. 7 is a front elevation view of still yet another embodiment of a lift vest of this disclosure.

FIG. 8 is a rear elevation view of the vest of FIG. 7.

FIG. 9 is a front elevation view of another embodiment of a lift vest of this disclosure.

FIG. 10 is a rear elevation view of the vest of FIG. 9.

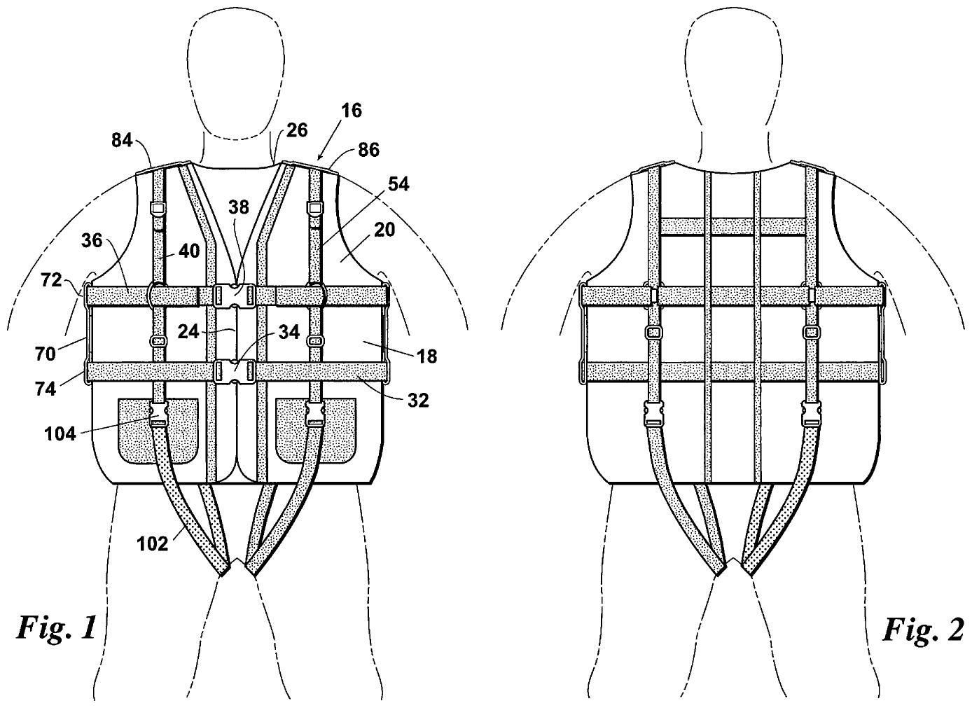

### DETAILED DESCRIPTION

In embodiments of a lift vest of this disclosure, the vest includes a garment with a lifting structure that helps transfer a caregiver's lifting force to the wearer's torso so the wearer may be lifted or moved. For purposes of this disclosure, torso refers to an area generally containing the chest, abdomen, and back. Upper torso means the chest and upper back (opposite that of the chest).

Lower torso means the abdomen and the lower back (opposite that of the abdomen). A lift vest means a device worn by a patient as a clothing item and configured for safe patient handling and mobility during transfer and repositioning of the patient in any direction: front, back, or side. The vest may be made of fabric suitable for clothing items. The vest is foldable and rollable (unlike vests that contain flotation)

Referring to the drawings, embodiments of a lift vest 16 of this disclosure include a basic fabric garment 18 that is similar in many respects to a sleeveless vest but includes a lifting structure surrounding and forming a part of the vest that provides numerous hand hold places that enable a caregiver to assist the vest wearer. The garment 18 may include sleeve holes 20, a front 24 that may be closeable open front, a neck opening 26, and may be sized to cover the wearer's torso. The neck opening 26 may be a V-shape or rounded neck opening. In other embodiments, the garment 18 is a poncho-style garment (no closeable open front). In some embodiments, the garment 18 does not include sleeve holes 20 and is intended to only cover the upper torso below the armpits. The garment 18 may include a fire-resistant fabric of a kind known in the art.

The lifting structure may include one or more belts 32, 36, 40, 54 made of webbing and received by respective loops 72, 74, 84, 86 connected to the garment 18. A double belt loop 70 may form loops 72, 74. In some embodiments, the garment 18 includes only a chest belt 36. Waist belt 32 may include a single or double adjustable buckle 34 so that the length of waist belt 32 can be adjusted to snugly but comfortably fit around the waist of the wearer. Similarly, chest belt 36 may include a single double adjustable buckle 38 so that the length of the chest belt 36 can be adjusted to snugly but comfortably fit around the upper torso portion of the patient. Waist belt 32 and chest belt 36 may be arranged horizontal and parallel to each other. In embodiments, the vest 16 may include shoulder straps 40, 54 the same or similar to those as disclosed in U.S. Pat. No. 6,122,778 to Cohen, the contents of which are incorporated by reference herein. The straps 40, 54 may include a shoulder lift strap secured to the straps 40, 54. Loops 84, 86 may serve as the lift strap.

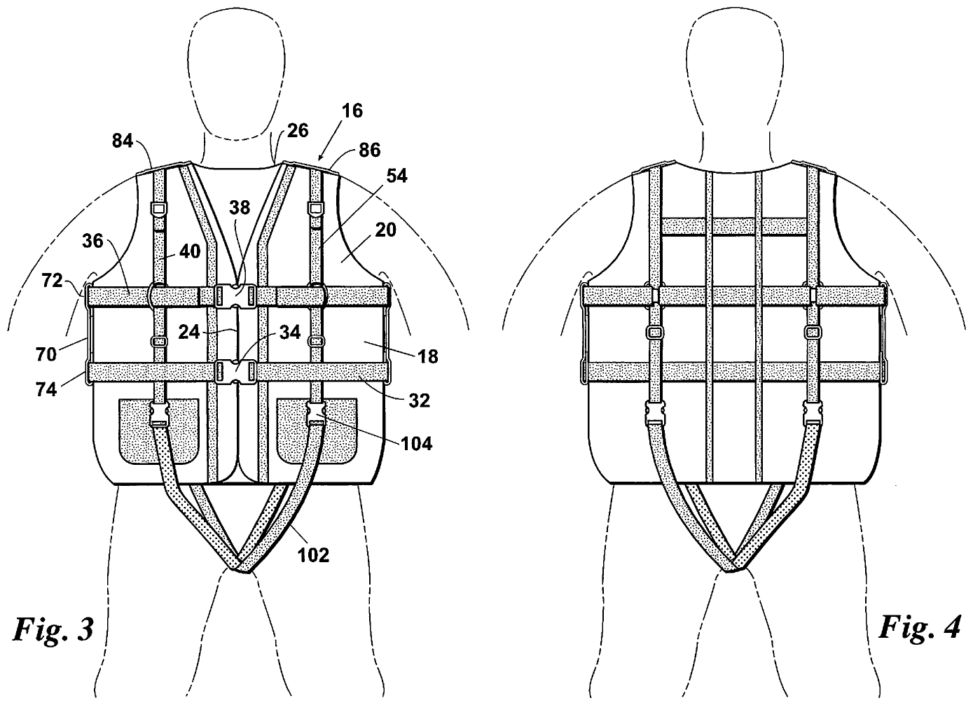

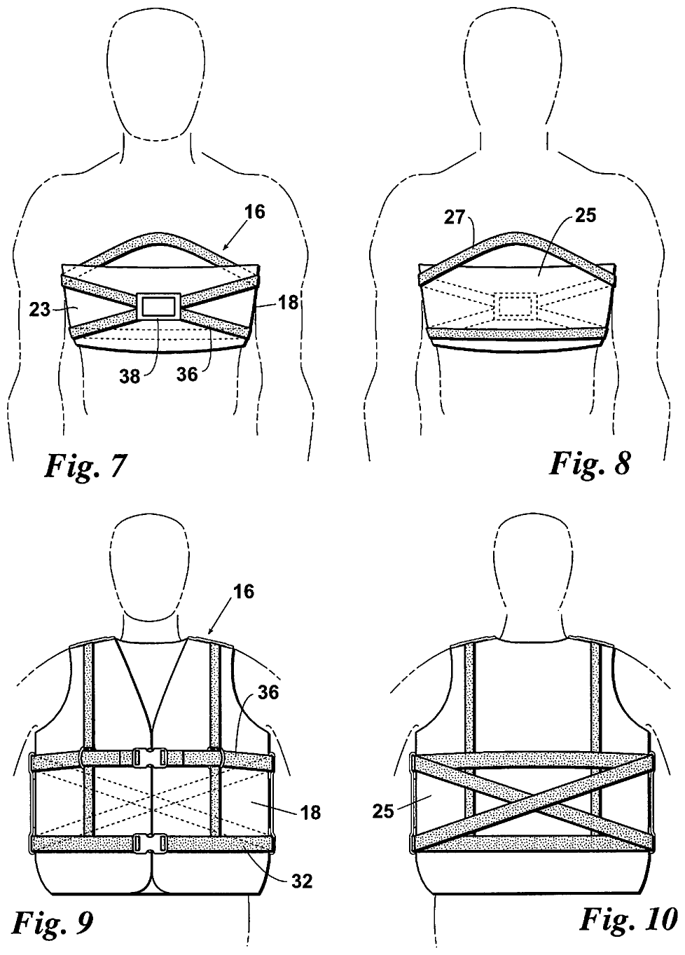

Embodiments of the lift vest 16 may include a pair of crotch belts 102 removably connected to the waist belt 32 by connectors 104. Connectors 104 may include quick-release buckles of a kind known in the art, hook-and-loop fastener of a kind known in the art, or some combination of the two. The connections may be adjustable connections. The crotch belts 102 help prevent the vest 16 from sliding upwards during vertical lifting movements. This is especially helpful when the wearer cannot bear her or his own weight. The crotch belts 102 may be crossed. See FIGS. 3 & 4. In some embodiments, the waist and chest belts 32, 36 may be configured like that shown in FIGS. 7 & 8 or 9 & 10.

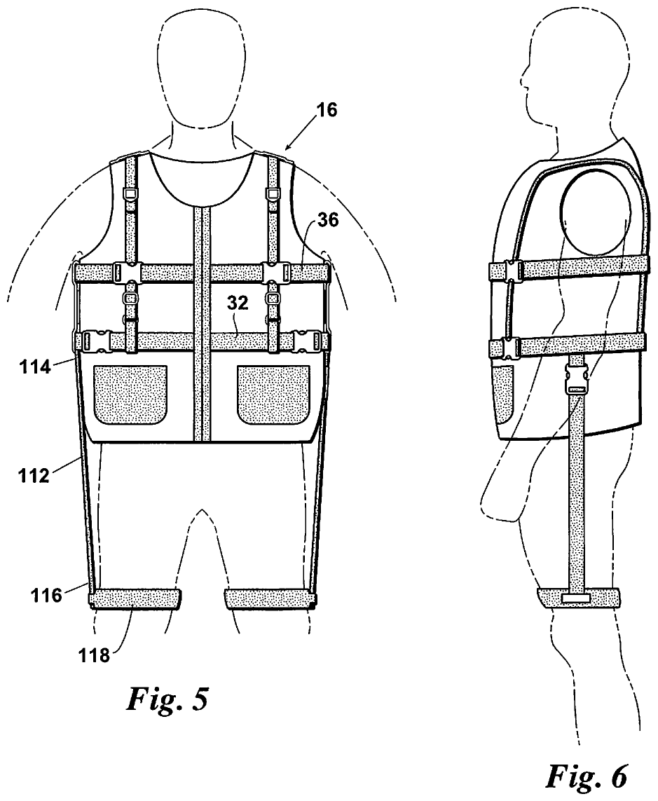

Referring now to FIGS. 5-6, embodiments of the lift vest 16 include a vertical belt 112 made of webbing that is fixedly or removably connected at one end 114 to the waist belt 32 and at another end 116 to a knee belt 118 (also made of webbing). The removable connections may be made using connectors the same as or similar to connectors 104. In embodiments, knee belt 118 is an adjustable belt and may include a hook-and-loop fastener. Similar to the crotch belts 102, knee belts 118 help prevent the vest 16 from sliding upwards during vertical lifting movements. In some embodiments, the waist and chest belts 32, 36 may be configured like that shown in FIGS. 7 & 8 or 9 & 10.

Referring now to FIGS. 7 & 8, embodiments of the lift vest 16 include a chest belt 36 made of webbing that overlaps on itself—crossing on front 23 of the garment 18—ending with a half-loop 27 located along the back 25 of the garment 18 that serves as a handle. The garment 18 is sized to cover the upper torso below the armpits and opens and closes with a single buckle 38. The vest 16, which may be used in emergency situations like those encountered in police, fire, and rescue operations, self-tightens when the handle is pulled, preventing the vest 16 from slipping off no matter how much force is applied during a drag or lift.

Referring now to FIGS. 9 & 10, embodiments of the lift vest 16 include interconnected chest and waist belts 32, 36, with the belts 32, 36 made of webbing and crossing one another along a back 25 of the garment. When a belt 32, 36 is pulled in any direction, the webbing tightens the garment 18 around the torso of the wearer, preventing the vest 16 from sliding in a vertical direction. In some embodiments, the vest 16 may also include crotch belts 102 or knee belts 118. See FIGS. 5 & 6.

While embodiments of the lifting vest have been described and illustrated, modifications apart from those shown or suggested here may be made without departing from the scope of the following claims. The terms that are employed in the claims draw their meaning from the use of the terms in the specification. The same terms employed in the prior art may be broader in meaning than specifically employed here. Whenever there is a question between the broader definition of such terms used in the prior art and the more specific use of the terms herein, the more specific meaning is meant.

1. A lift vest including a base garment providing hand holds connected to the base garment by which a caregiver may assist a wearer of the lift vest in moving from one position to another or in standing or walking, the lift vest comprising:
a chest belt;
a waist belt; and
a pair of crotch belts, each crotch belt of the pair including two ends removably connected to the waist belt.

2. The lift vest of claim 1, further comprising:
the chest and waist belt interconnected and crossing over one another along a back of the base garment.

3. A lift vest including a base garment providing hand holds connected to the base garment by which a caregiver may assist a wearer of the lift vest in moving from one position to another or in standing or walking, the lift vest comprising:
a chest belt;
a waist belt; and
a pair of vertical belts, each vertical belt of the pair connected at one end to the waist belt; and
a pair of knee belts, each knee belt of the pair connected to another end of the vertical belt.

4. The lift vest of claim 3, further comprising:
the chest and waist belt interconnected and crossing over one another along a back of the base garment.

5. The lift vest of claim 3, further comprising:
the one end of each vertical belt connected to the waist belt including a removeable connector.

6. The lift vest of claim 3, further comprising:
the another end of each vertical belt connected to the knee belt including a removeable connector.

7. The lift vest of claim 3, further comprising:
each knee belt being an adjustable knee belt.

8. A lift vest including a base garment providing hand holds connected to the base garment by which a caregiver may assist a wearer of the lift vest in moving from one position to another or in standing or walking, the lift vest comprising:
a chest belt;
a waist belt;
the chest and waist belt interconnected and crossing over one another along a back of the base garment.

9. The lift vest of claim 8, further comprising:
a pair of crotch belts, each crotch belt of the pair including two ends removably connected to the waist belt.

10. The lift vest of claim 8, further comprising:
a pair of vertical belts, each vertical belt of the pair connected at one end to the waist belt; and
a pair of knee belts, each knee belt of the pair connected to another end of the vertical belt.

11. The lift vest of claim 10, further comprising:
the one end of each vertical belt connected to the waist belt including a removeable connector.

12. The lift vest of claim 10, further comprising:
the another end of each vertical belt connected to the knee belt including a removeable connector.

13. The lift vest of claim 10, further comprising:
each knee belt being an adjustable knee belt.

14. A lift vest including a base garment providing hand holds connected to the base garment by which a caregiver may assist a wearer of the lift vest in moving from one position to another or in standing or walking, the lift vest comprising:
a buckle;
a single belt passing through the buckle and crossing over itself on a front of the base garment and ending in a loop on a back of the base garment;
the base garment having no sleeve holes;
wherein when a pulling force is applied to the loop, the single belt compresses the base garment.

15. The lift vest of claim 14, the loop running parallel to another portion of the single belt on the back of the base garment.
